(19) United States
(12) Patent Application Publication
(10) Pub. No.: US 2011/0017752 A1
(43) Pub. Date: Jan. 27, 2011

(54) CARTRIDGE OF GAS-LIQUID FUEL

(75) Inventors: Eric Carrato, Chaussan (FR); René Caillard, Chaponost (FR)

Correspondence Address: The Coleman Company, 3600 North Hydraullic, IP Legal- 11702, WICHITA, KS, 67219, US

(73) Assignee: APPLICATION DES GAZ, Saint Genis Laval (FR)

(21) Appl. No.: 12/303,685

(22) PCT Filed: Apr. 17, 2007
(86) PCT No.: PCT/FR07/00644

§ 371 Date: Oct. 6, 2010

(30) Foreign Application Priority Data
Jun. 6, 2006 (FR) 06 05011

(51) Int. Cl. F17C 13/04; F17C 1/00

(52) U.S. Cl. 220/583

(57) ABSTRACT

A liquid fuel gas cartridge having a valve that prevents or reduces the unintended escape of pressurized fluid after the cartridge has been perforated.

### CROSS REFERENCE TO RELATED APPLICATIONS

This patent application claims the benefit of PCT/FR07/000644 filed Apr. 17, 2007, which claims priority to French Application No. 06.05011 filed Jun. 6, 2006, both of which are incorporated herein.

### TECHNICAL FIELD

The present invention relates to a cartridge of liquid fuel gas.

### BACKGROUND OF THE INVENTION

It is known practise to use liquid fuel gas cartridges of the type comprising:
a reservoir having a portion that can be perforated on its wall, and
a device designed to prevent or reduce the escape of pressurized fluid after the cartridge has been perforated, comprising a valve furnished with a seal designed to be pressed against the wall of the reservoir around the perforatable portion by elastic means designed to press directly or indirectly against a wall of the reservoir.

This type of cartridge makes it possible effectively to reduce or eliminate the leakage of the fluid from the cartridge, after perforation, provided that the cartridge is used according to its optimal operation.

Such a cartridge is in particular designed to be used with a gas apparatus comprising a perforator. The perforator must penetrate the cartridge vertically in the center of the perforatable portion, in the normal conditions of use of the gas apparatus. However, when the gas apparatus is not mounted on the cartridge according to the instructions of use, it may be that the perforator pierces the cartridge at an angle relative to the axis of the cartridge, or in an eccentric manner relative to the perforatable portion.

In these conditions, the seals provided between the cartridge and the apparatus are not positioned to seal the assembly, while the valve designed to prevent the leakage is displaced by the perforator. Consequently, a gas leak may occur.

The technical problem at the basis of the invention is therefore to provide a cartridge that does not allow a leak of fluid when the apparatus is mounted onto the cartridge in a position that does not correspond to the normal conditions of use.

### SUMMARY OF THE INVENTION

Accordingly, the subject of the present invention is a cartridge of the aforementioned type, characterized in that the valve comprises, facing the perforatable portion:
a central portion situated at a first distance from the perforatable portion, less than the length of the portion of a perforator designed to penetrate the reservoir and
a peripheral portion situated at a second distance from the perforatable portion, greater than the length of the portion of a perforator designed to penetrate the reservoir.

Thanks to the arrangements according to the invention, if the cartridge is wrongly positioned relative to the gas apparatus, and the perforator of this apparatus penetrates the reservoir in an inclined manner relative to the axis of the reservoir, or is offset relative to the center of the perforatable portion, this perforator will not come into contact with the central portion of the valve. On the contrary, the tip of the perforator will be situated opposite the peripheral portion of the valve, situated relative to the perforatable portion at a distance greater than the length of the perforator penetrating the cartridge. Consequently, the perforator does not move the valve, and the gas leak is avoided.

In normal conditions of use, the perforator being substantially in the axis of the reservoir, the tip of the perforator comes into contact with the central portion of the valve, situated relative to the perforatable portion at a distance less than the length of the perforator penetrating the cartridge. The perforator therefore moves the valve, and the gas may be delivered to the outside of the cartridge.

Advantageously, the valve comprises a portion of support of the seal, outside the peripheral zone, comprising a rim on the outside of which the seal is housed.

The rim makes it possible to protect the seal against damage due to the tip of the perforator if the latter penetrates the reservoir in an eccentric or inclined manner relative to the perforatable portion. In addition, this rim makes it possible to protect the seal from the contact of chips that are cut away during the perforation of the cartridge.

According to one embodiment, the seal is housed in a groove of the portion of support, turned toward the wall of the reservoir. The groove in particular forms the protective rim.

Advantageously, the seal is placed so as to press on the wall of the reservoir in a zone outside the perforatable portion.

This positioning of the seal makes it possible to protect the latter against damage due to the tip of the perforator if the latter penetrates the reservoir in an eccentric or inclined manner relative to the perforatable portion.

Advantageously, the elastic means press on a support fixed, notably by welding, to the wall of the reservoir.

According to one embodiment, the cartridge comprises means for retaining the valve relative to the support, said means being designed to make the valve captive relative to the support.

These arrangements allow the valve and the support, and the elastic means, to remain attached before the support is fixed to the cartridge.

So that it can be fully understood, the invention is described with reference to the drawing appended hereto representing, as a nonlimiting example, a gas cartridge according to the invention.

### BRIEF DESCRIPTION OF THE DRAWINGS

FIG. 1 represents a view in partial longitudinal section of a cartridge according to the invention.

FIG. 2 represents a view in partial longitudinal section of a cartridge according to the invention, on a sectional plane perpendicular to that of FIG. 1, on a larger scale.

FIG. 3 represents a view in section of a gas apparatus comprising a perforator.

### DESCRIPTION OF THE PREFERRED EMBODIMENTS

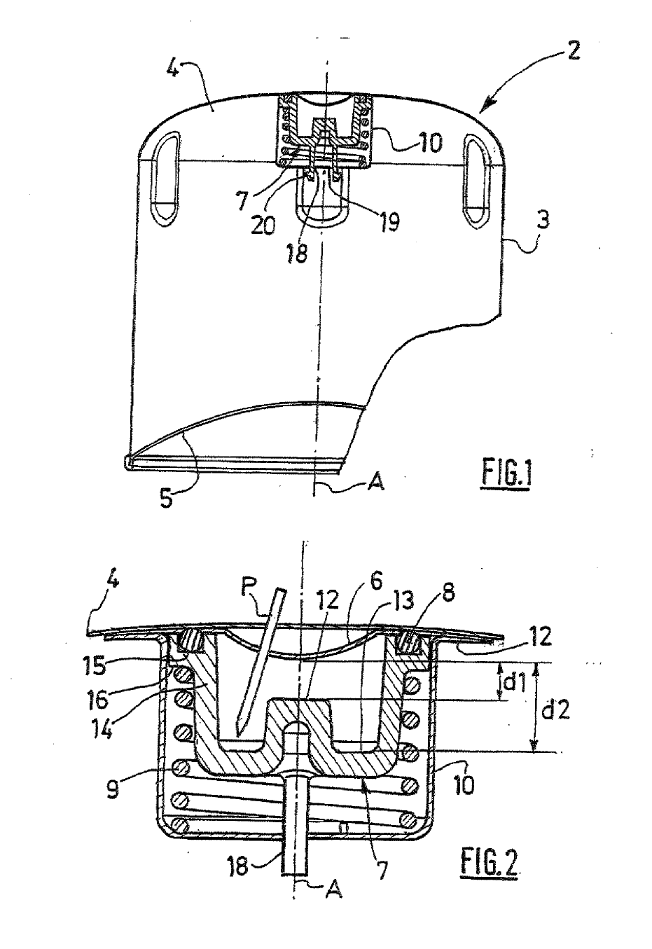

According to one embodiment represented in FIGS. 1 and 2, a cartridge 2 of liquid fuel gas according to the invention comprises a reservoir 3 having a cylindrical peripheral wall extended on one side by a dome 4, and closed on the other side by a swaged bottom 5.

The wall of the reservoir 3 comprises a perforatable portion 6 in the shape of a concave dish situated on the top of the dome, on the axis A of the cylindrical peripheral wall of the reservoir 3.

The cartridge 2 comprises, inside the reservoir 3, a device designed to prevent or reduce the leakage of pressurized fluid after the perforation of the cartridge.

This device comprises a valve 7 furnished with a seal 8 designed to be pressed against the wall of the reservoir 3 around the perforatable portion 6 by a coil spring 9 pressing on a support 10 welded to the wall of the reservoir 3, around the perforatable portion 6, at a distance from the latter.

The valve 7 comprises, opposite the perforatable portion 6:
a central portion 12 situated at a first distance d1 from the perforatable portion 6, that is less than the length of the portion of a perforator P designed to penetrate the reservoir 3, and
a peripheral portion 13 situated at a second distance d2 from the perforatable portion 6, that is greater than the length of the portion of a perforator P designed to penetrate the reservoir 3.

The valve 7 also comprises a portion 14 of support of the seal 8, outside the peripheral portion 13, comprising a groove 15 for housing the seal 8, turned toward the wall of the reservoir 3. The seal is placed so as to press on the wall of the reservoir 3 in a zone outside the perforatable portion 6.

On the side opposite to the perforatable portion 6, the valve comprises an outer shoulder 16 on which the spring 9 bears. The valve 7 also comprises two elastic claws 18 extending through an opening 19 in the support 10, and comprising a stop 20 at its end. These claws constitute a means for retaining the valve 7 relative to the support, making it possible to make the valve 7 captive relative to the support before the latter is fixed to the reservoir 3.

In the embodiment shown in FIGS. 1 and 2, the support 10 consists of a part comprising a cylindrical side wall, with an external return 22 designed to be fixed to the wall of the reservoir 3, particularly by welding, and a bottom in which the opening 19 is arranged in which the claws 18 of the valve are engaged.

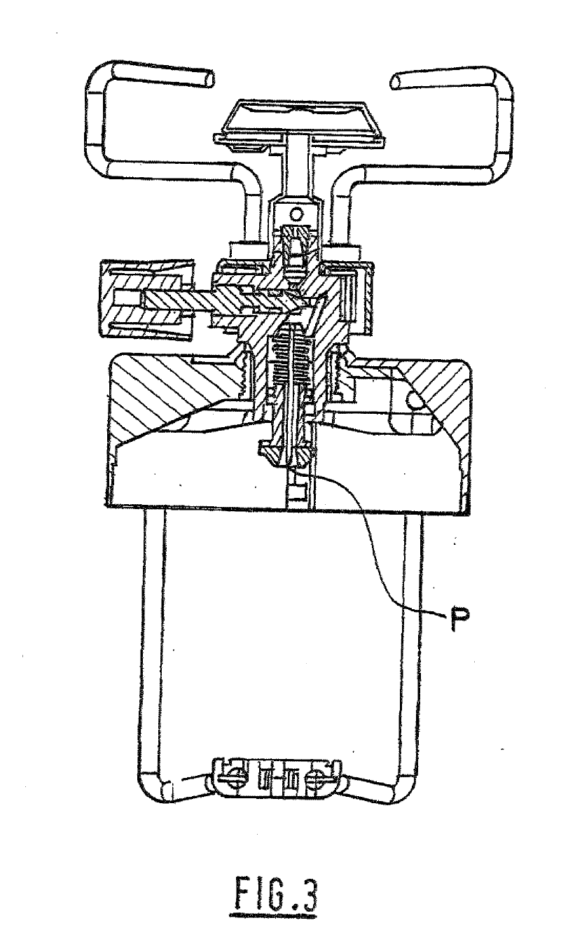

As can be seen in FIG. 2, if the cartridge is incorrectly positioned relative to a gas apparatus, for example of the type shown in FIG. 3, and the perforator P of this apparatus penetrates the reservoir in an inclined manner relative to the axis of the reservoir, or is offset relative to the center of the perforatable portion, this perforator will not come into contact with the central portion 12 of the valve. On the contrary, the tip of the perforator will be situated opposite the peripheral portion 13 of the valve, situated relative to the perforatable portion 6 at a distance d2 that is greater than the length of the perforator P penetrating the cartridge.

It goes without saying that the invention is not limited to the preferred embodiment described above, as a nonlimiting example; on the contrary it covers all the variants thereof.

1. A cartridge of liquid fuel gas, comprising:
a reservoir having a portion that can be perforated on its wall, and
a device designed to prevent or reduce the escape of pressurized fluid after the cartridge has been perforated, comprising a valve furnished with a seal designed to be pressed against the wall of the reservoir around the perforatable portion by elastic means designed to press directly or indirectly against a wall of the reservoir,
wherein
the valve comprises, facing the perforatable portion:
a central portion situated at a first distance from the perforatable portion, less than the length of the portion of a perforator designed to penetrate the reservoir and
a peripheral portion situated at a second distance from the perforatable portion, greater than the length of the portion of a perforator designed to penetrate the reservoir.

2. The cartridge as claimed in claim 1, wherein the valve comprises a portion of support of the seal, outside the peripheral zone, comprising a rim on the outside of which the seal is housed.

3. The cartridge as claimed in claim 2, wherein the seal is housed in a groove of the portion of support, turned toward the wall of the reservoir.

4. The cartridge as claimed in one of claims 1 to 3, wherein the seal is placed so as to press on the wall of the reservoir in a zone outside the perforatable portion.

5. The cartridge as claimed in one of claims 1 to 4, wherein the elastic means press on a support fixed, notably by welding, to the wall of the reservoir.

6. The cartridge as claimed in claim 5, comprising means for retaining the valve relative to the support, said means being designed to make the valve captive relative to the support.
